(19) United States
(12) Patent Application Publication
(10) Pub. No.: US 2008/0060830 A1
(43) Pub. Date: Mar. 13, 2008

(54) Wiring box

(76) Inventor: Li Chung Hsien, Taiping (TW)

Correspondence Address: BRUCE H. TROXELL, SUITE 1404, 5205 LEESBURG PIKE, FALLS CHURCH, VA, 22041, US

(21) Appl. No.: 11/518,407

(22) Filed: Sep. 11, 2006

(51) Int. Cl. H01H 23/04

(52) U.S. Cl. 174/53

(57) ABSTRACT

A wiring box includes a box body made of suitable metallic material. The wiring box body has its circumferential wall and its bottom bored with plural insert holes at preset locations. The wiring box body is formed with an open upper side having two opposite lateral edges respectively disposed with a lug and two opposite lengthwise edges respectively formed integrally with a plurality of conical nails. The lugs protruding inward horizontally are respectively bored with a threaded hole, and the conical nails protrude outward axially at a same level from the lengthwise edge of the open upper side of the wiring box body. The wiring box can be firmly secured on a pattern plate by directly driving the conical nails into the pattern plate, able to firmly fix the wiring box on the pattern plate quickly without using screws.

### BACKGROUND OF THE INVENTION

1. Field of the Invention

This invention relates to a wiring box, particularly to one formed integral with a plurality of conical nails at the circumferential edge of its open upper side. The wiring box can be firmly secured on a pattern plate by directly driving the conical nails into the pattern plate, able to secure the wiring box on the pattern plate quickly without using screws.

2. Description of the Prior Art

A conventional wiring box is formed with a cover body having its circumferential wall bored with a plurality of insert holes and its bottom bored with a plurality of threaded holes at preset locations. Thus, the conventional wiring box can be firmly locked on a pattern plate by means of screws respectively screwed in the threaded holes at the bottom of the cover body.

However, to secure the conventional wiring box on the pattern plate on reinforced concrete (RC) by screws respectively screwed into the threaded holes at the bottom of the wiring box, hand tools must be used for driving the screws and fixing the wiring box on the pattern plate, thus causing much trouble and convenience. If screws are driven into the threaded holes of the wiring box by a nail-driving machine and if the screws are too long, it will be difficult to remove the pattern plate from the reinforced concrete. On the other hand, if the screws are too short, the wiring box is likely to fall off or shift during carrying out grouting work of concrete.

### SUMMARY OF THE INVENTION

The objective of the invention is to offer a wiring box, including a box body made of metallic material. The box body has its circumferential wall and its bottom respectively bored with a plurality of insert holes and has an open upper side with two opposite lateral edges respectively provided with a lug and two opposite lengthwise edges respectively formed integrally with a plurality of conical nails at preset locations. The two opposite lugs protrude inward horizontally and respectively bored with a threaded hole, and the conical nails protrude outward axially at a same level from the two lengthwise edges of the open upper side of the box body. By so designing, the wiring box can be firmly secured on a pattern plate by having the conical nails of the box body directly driven into the pattern plate, able to quickly secure wiring boxes on pattern plates without using screws.

### BRIEF DESCRIPTION OF DRAWINGS

This invention will be better understood by referring to the accompanying drawings, wherein:

FIG. 1 is a perspective view of a first preferred embodiment of a wiring box in the present invention;

FIG. 2 is a side view of the first preferred embodiment of the wiring box locked on a pattern plate in the present invention;

FIG. 3 is a perspective view of a second preferred embodiment of a wiring box in the present invention; and

FIG. 4 is a perspective view of the second preferred embodiment of the wiring box locked on a pattern plate in the present invention.

### DETAILED DESCRIPTION OF THE PREFERRED EMBODIMENT

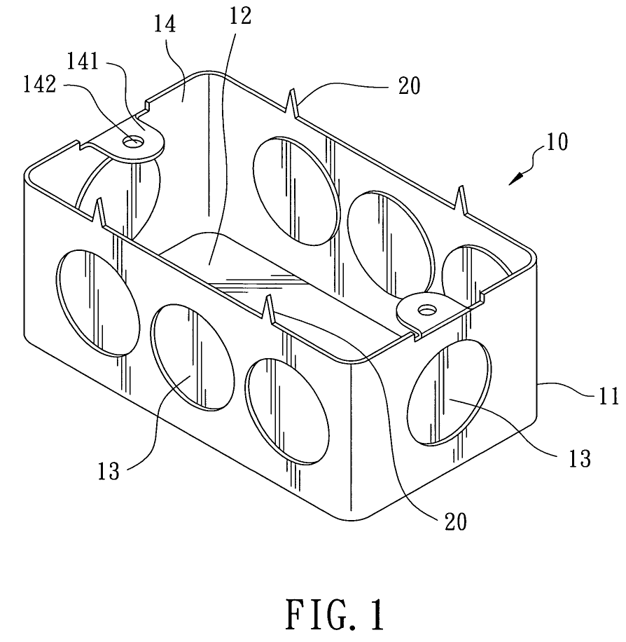

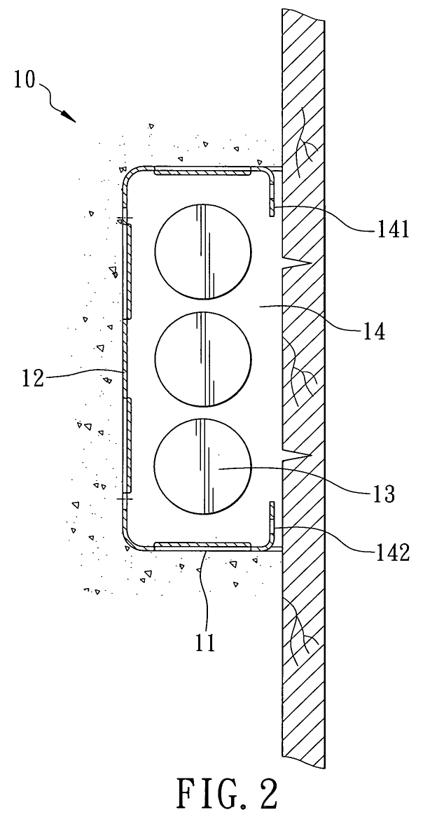

A first preferred embodiment of a wiring box in the present invention, as shown in FIGS. 1 and 2, includes a wiring box body 10 made of suitable metallic material. The wiring box body 10 has its circumferential wall 11 and its bottom 12 respectively bored with a plurality of insert holes 13 and has its upper side formed with an open end 14 having two short upper edges respectively provided with a lug 141 extending inward horizontally and bored with a threaded hole 142.

At least two conical nails 20 are formed integral at two opposite lengthwise edges of the open upper side 14 of the wiring box body 10. The two conical nails 20 protruding outward axially at a same level are respectively positioned to face each other on the two lengthwise edge of the open upper side 14 of the wiring box body 10. In this preferred embodiment, the wiring box body 10 is formed with four conical nails 20 protruding outward from two the lengthwise edges of the open upper side 14. In addition, the length of the conical nail 20 is approximately equivalent to that of the lug 141.

In using, as shown in FIG. 2, the conical nails 20 on the lengthwise edges of the open upper side 14 of the wiring box body 10 are forcedly driven into the pattern plate to secure the wiring box body 10 at a preset location on the surface of the pattern plate. Thus, the wiring box body 10 can be locked on the pattern plate without using screws before carrying out grouting work of concrete, able to secure the wiring box on the pattern plate quickly and prevent it from shifting during carrying out concrete grouting, and facilitating removal of the pattern plate from the reinforced concrete.

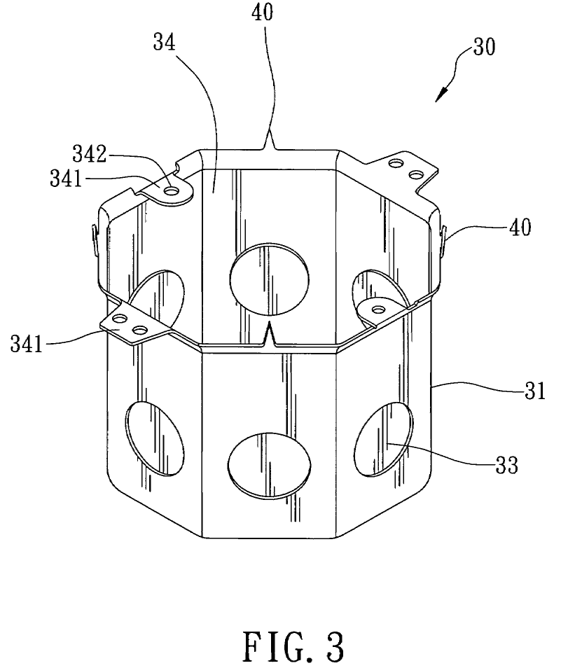

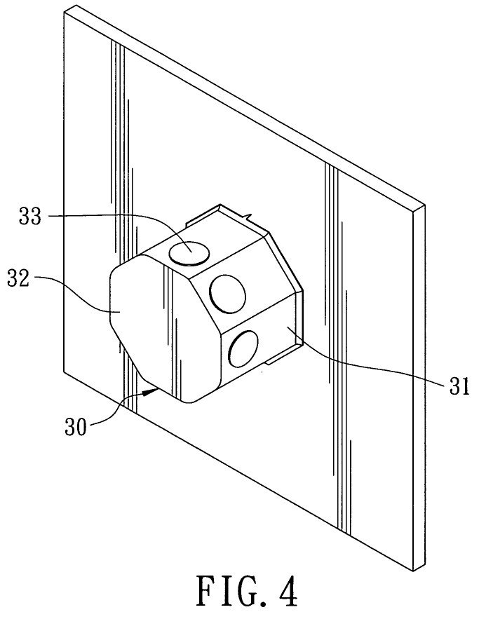

A second preferred embodiment of a wiring box in the present invention, as shown in FIGS. 3 and 4, includes an octagonal wiring box body 30 having its circumferential wall 31 and its bottom 32 respectively bored with a plurality of insert holes 33. The wiring box body 30 has a pair of lugs 341 with a threaded hole 342 protruding inward on two opposite edges of its open upper side 34, and another pair of lugs 341 with two threaded holes 342 protruding outward on other two opposite edges of the open upper side 34. Further, the open upper side 34 has a plurality of conical nails 49 formed on two opposite edges, protruding outward axially at a same level. The function of the wiring box body 30 of this second preferred embodiment is the same as that of the wiring box body 20 of the first preferred embodiment.

To sum up, this invention has the following advantages.

1. The wiring box can be quickly secured on the pattern plate by forcedly driving its conical nails into the pattern plate, needless to use screws.

2. The length of the conical nail formed integral on the upper edge of the wiring box is approximately equivalent to that of the lug; therefore, after the conical nails with a moderate length are driven into the pattern plate, the wiring box can be firmly secured on the pattern plate, and the pattern plate can be easily removed from the reinforced concrete.

While the preferred embodiments of the invention have been described above, it will be recognized and understood that various modifications may be made therein and the appended claims are intended to cover all such modifications that may fall within the spirit and scope of the invention.

I claim:

1. A wiring box comprising a box body made of suitable metallic material, said wiring box body having its circumferential wall and its bottom respectively bored with a plurality of insert holes at preset locations, said wiring box body formed with an open upper side having two opposite lateral edges respectively formed with a lug with a threaded hole: and,
Characterized by a plurality of conical nails formed integral on two lengthwise edges of said open upper side of said wiring box body, said conical nails protruding outward axially at a same level at preset locations of said two lengthwise edges of said open upper side of said wiring box body.

2. The wiring box as claimed in claim 1, wherein said wiring box body is formed integrally with at least two conical nails respectively positioned diagonally on said lengthwise edges of said open upper side.

3. The wiring box as claimed in claim 1, wherein the length of said conical nail is approximately equivalent to that of said lug.
